(19) United States
(12) Patent Application Publication
(10) Pub. No.: US 2006/0257196 A1
(43) Pub. Date: Nov. 16, 2006

(54) MECHANISM FOR POSITIONING A STYLUS

(76) Inventors: Shih-Huei Liu, Taipei City (TW); Chin-Hsien Chang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,044

(22) Filed: Aug. 26, 2005

(30) Foreign Application Priority Data
May 12, 2005 (TW) 94115332

(51) Int. Cl. B43K 23/00; A45D 40/20

(52) U.S. Cl. 401/88

(57) ABSTRACT

A mechanism for positioning a stylus inside an electronic device is provided. The stylus positioning mechanism comprises a position-limiting element, a pen cap, a pushing element, a linking rod, a stopping block and a repositioning element. The position-limiting element has an accommodating space for housing the stylus. The pen cap is disposed at one end of the position-limiting element for gripping the stylus. The pushing element is fastened to the pen cap for pushing the stylus out from the position-limiting element. The linking rod is fastened to the pen cap so that it moves together with the pen cap. The stopping block is disposed on the side edge of the position-limiting element for restricting the movement of the linking rod in the latched position or the unlatched position. The repositioning element is fastened to the stopping block for repositioning the stopping block to the latched position.

### CROSS-REFERENCE TO RELATED APPLICATION

This application claims the priority benefit of Taiwan application serial no. 94115332, filed on May 12, 2005. All disclosure of the Taiwan application is incorporated herein by reference.

### BACKGROUND OF THE INVENTION

1. Field of the Invention

The present invention relates to a positioning mechanism. More particularly, the present invention relates to a mechanism for positioning a stylus inside an electronic device such that the stylus can be easily taken out or put back.

2. Description of the Related Art

With the rapid advance of personal computer manufacturing techniques, the original desktop computer has developed and diversified into many types of portable computers including notebook computers, personal digital assistants (PDA) and pocket personal computers.

Because all these mobile portable computers such as personal digital assistants or palm-top computers must be thin, light, compact and small, a keyboard is often not provided or an externally connected keyboard is provided if an instruction input function is required. To input instructions in the absence of a keyboard, handwriting or touch-control input function is frequently provided through the display panel of the mobile computer. At present, a display panel having handwriting or touch-control input function commonly uses a stylus to touch the display panel so as to prevent the finger of a user from directly touching the display panel and causes damage.

It should be noted that, in consideration of the inconvenience of a user who has to carry a stylus separately, most mobile computers having touch control input function are provided with a position-limiting element on one of the sides of the machine body for housing a stylus. With the stylus mounted inside the mobile computer, the stylus can be retrieved wherever and whenever one desires.

### SUMMARY OF THE INVENTION

Accordingly, at least one objective of the present invention is to provide a positioning mechanism that facilitates the housing of a stylus inside an electronic device.

At least a second objective of the present invention is to provide a positioning mechanism that facilitates a user to retrieve a stylus from an electronic device.

To achieve these and other advantages and in accordance with the purpose of the invention, as embodied and broadly described herein, the invention provides a positioning mechanism for housing a stylus inside an electronic device. The positioning mechanism comprises a position-limiting element, a pen cap, a pushing element, a linking rod, a stopping block and a repositioning element. The position-limiting element constitutes an accommodating space for housing the stylus. The pen cap is disposed at one end of the position-limiting element for gripping the stylus. The pushing element is fastened to the pen cap. When the pushing element is compressed after receiving an external force, a pushing force will be provided by the pushing element to move the stylus out of the position-limiting element in a longitudinal direction. The linking rod is fastened to the pen cap so that it moves together with the pen cap. The stopping block is disposed on the side edge of the position-limiting element for moving from a latched position to an unlatched position. When the stopping block is shifted to the latched position, the stopping block restricts the movement of the linking rod. On the other hand, when the stopping block is shifted to the unlatched position, the stopping block will not limit the movement of the linking rod. The repositioning element is fastened to the stopping block. When the repositioning element is compressed, the repositioning element generates a force pushing the stopping block so that the stopping block returns to the latched position.

According to one embodiment of the present invention, the linking rod is a stopping block receiver having a stopping function and the linking rod extends a definite distance from the pen cap in the longitudinal direction of the stylus toward the stopping block.

According to one embodiment of the present invention, the pen cap further includes a gripping element for gripping a circular groove thread.

According to one embodiment of the present invention, the pushing element is a spring, for example.

According to one embodiment of the present invention, the positioning mechanism further includes a rocking arm having a fixed end and a free end. The fixed end is fastened to the position-limiting element and the free end is permitted to oscillate with respect to the fixed end when the free end is subjected to an eternal force. Furthermore, the stopping block is fastened to the rocking arm between the fixed end and the free end so that the stopping block can follow the motion of the rocking arm.

According to one embodiment of the present invention, the repositioning element is a spring, for example.

The present invention also provides an alternative positioning mechanism for housing a stylus inside an electronic device. The stylus positioning mechanism comprises a position-limiting element, a pen cap, a pushing element, a bulging circular ring, a stopping block and a repositioning element. The position-limiting element constitutes an accommodating space for housing the stylus. The pen cap is disposed at one end of the position-limiting element for gripping the stylus. The pushing element is fastened to the pen cap. When the pushing element is compressed after receiving an external force, a pushing force will be provided by the pushing element to move the stylus out of the position-limiting element in a longitudinal direction. The bulging circular ring is fastened to the stylus pen so that it moves together with the stylus. The stopping block is disposed on the side edge of the position-limiting element for moving from a latched position to an unlatched position. When the stopping block is shifted to the latched position, the stopping block restricts the movement of the bulging circular ring. On the other hand, when the stopping block is shifted to the unlatched position, the stopping block will not limit the movement of the bulging circular ring. The repositioning element is fastened to the stopping block. When the repositioning element is compressed, the repositioning element generates a force pushing the stopping block so that the stopping block returns to the latched position.

According to one embodiment of the present invention, the bulging circular ring is a stopping block receiver with stopping function. The bulging circular ring surrounds the periphery of the stylus.

According to one embodiment of the present invention, the pen cap further includes a gripping element for gripping a circular groove thread.

According to one embodiment of the present invention, the pushing element is a spring, for example.

According to one embodiment of the present invention, the positioning mechanism further includes a rocking arm having a fixed end and a free end. The fixed end is fastened to the position-limiting element and the free end is permitted to oscillate with respect to the fixed end when the free end is subjected to an eternal force. Furthermore, the stopping block is fastened to the rocking arm between the fixed end and the free end so that the stopping block can follow the motion of the rocking arm.

According to one embodiment of the present invention, the repositioning element is a spring, for example.

Accordingly, the positioning mechanism of the present invention utilizes the pushing element to push the stylus so that a portion of the stylus is exposed outside the electronic device. Thus, a user can easily get hold of the stylus and pull it out. When the stylus needs to be housed inside the electronic device, the user can indirectly apply a force to the repositioning element by moving the outer edge of the stylus until the repositioning element drives the stopping block from the unlatched position back to the latched position. Through the structural interference between the stopping block and the stopping block receiver, the position of the stylus within the position-limiting element is restricted. Hence, the stylus concealed inside the electronic device is firmly gripped and unlikely to fall out.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view showing a positioning mechanism accommodating a stylus inside an electronic device according to a first embodiment of the present invention.

FIG. 2 is an exploded view showing the major components of a positioning mechanism and associated stylus according the first embodiment of the present invention.

FIG. 3 is a perspective view showing the components of a positioning mechanism and associated stylus assembled together according to the first embodiment of the present invention.

FIGS. 4A˜4C are a series of side views showing the process of ejecting a stylus from a positioning mechanism according to the first embodiment of the present invention.

FIGS. 5A˜5C are a series of side views showing the process of returning a stylus to the positioning mechanism according to the first embodiment of the present invention.

FIG. 6 is an exploded view showing the major components of a positioning mechanism and associated stylus according a second embodiment of the present invention.

FIGS. 7A˜7C are a series of side views showing the process of ejecting a stylus from a positioning according to the second embodiment of the present invention.

FIGS. 8A˜8C are a series of side views showing the process of returning a stylus to the positioning mechanism according to the second embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

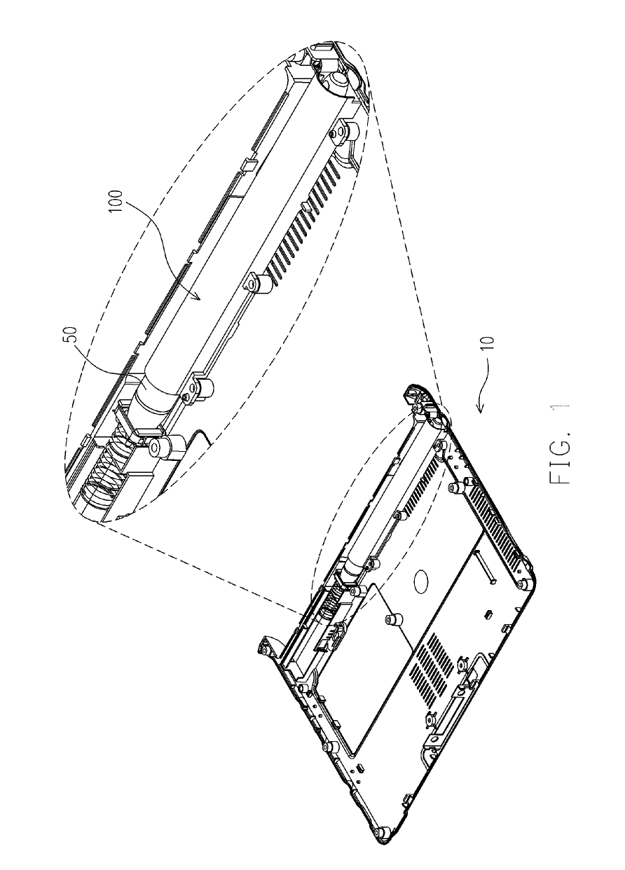

FIG. 1 is a perspective view showing a positioning mechanism accommodating a stylus inside an electronic device according to a first embodiment of the present invention. In FIG. 1, only a local portion of the outer casing of the electronic device 10 such as a personal digital assistant, palm-top computer or smart phone is displayed. The positioning mechanism 100 for accommodating a stylus 50 is disposed on one side of the electronic device 10.

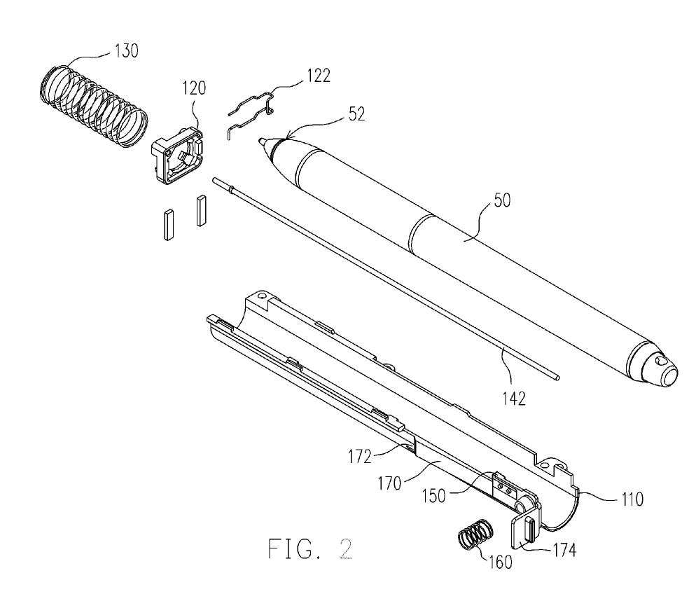

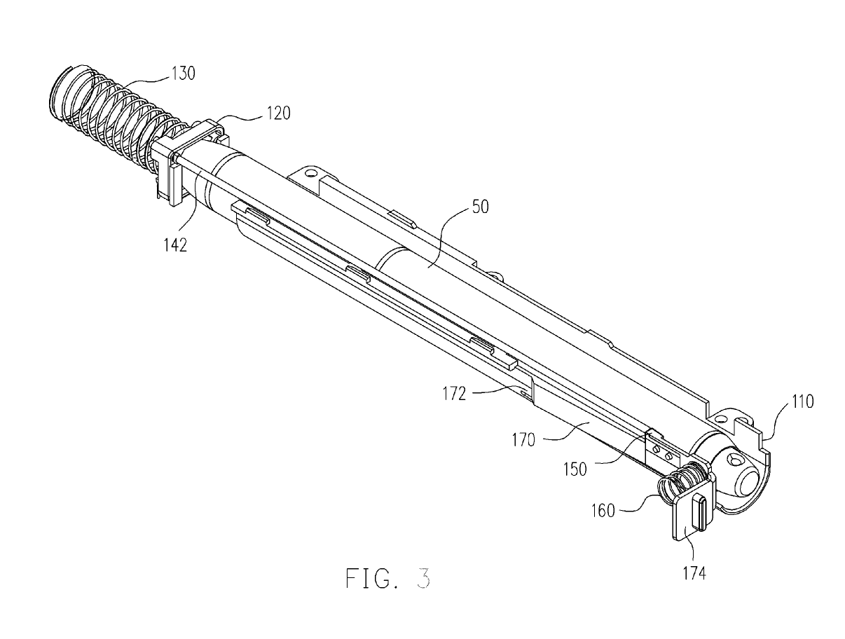

FIG. 2 is an exploded view showing the major components of a positioning mechanism and associated stylus according to the first embodiment of the present invention. FIG. 3 is a perspective view showing the components of a positioning mechanism and associated stylus assembled together according to the first embodiment of the present invention. As shown in FIGS. 1, 2 and 3, the fastening mechanism 100 includes a position-limiting element 110, a pen cap 120, a pushing element 130, a linking rod 142, a stopping block and a repositioning element 160. The position-limiting element 110 is disposed inside the electronic device 10. The positioning-limiting element 10 constitutes an accommodating space for housing the stylus 50 and restricts the movement of the stylus 50 along the longitudinal direction. In the present embodiment, the space constituted by part of the inner walls of the casing of the position-limiting element 110 and the electronic device 10 is used to accommodate the stylus 50.

The pen cap 120 is disposed on one end of the position-limiting element 110 for gripping the stylus 50 and positioning the stylus 50 inside the position-limiting element 110. Furthermore, the pen cap 120 plugged into the stylus 50 also moves together with the stylus 50. In the present embodiment, the pen cap 120 further includes a clamping element 122 such as a bent segment made from a metallic wire. The clamping element 122 is clipped on the pen cap 120 for embracing a circular groove thread 52 on the stylus 50. Hence, the stylus 50 can be firmly attached inside the electronic device 10.

The pushing element 130 is fastened to the pen cap 120. When the pushing element 130 is compressed, a force is created to push the pen cap 120 so that at least the tail end of the stylus 50 is pushed outside the position-limiting element 110. In the present embodiment, the pushing element 130 is a spring, for example.

The linking rod 142 is fastened to the pen cap 120. Furthermore, the linking rod 142 will move together with the pen cap 120. In the present embodiment, the linking rod 142 is firmly attached to the pen cap 120. When the pen cap 120 moves due to a compression or extension of the pushing element 130, the linking rod 142 will move together with the pen cap 120 and push the stylus 50 into or away from the position-limiting element 110.

The stopping block 150 is disposed on the side edge of the positioning element 110. The stopping block 150 restricts the movement of the linking rod 142 in a latched position. When the stopping block 150 is moving from the latched position to the unlatched position as a result of an externally applied force, the stopping block will not restrict the movement of the linking rod 142. The repositioning element 160 is fastened to the stopping block 150. When the repositioning element 160 is compressed, a force pushing the stopping block 150 is generated so that the stopping block 150 returns to its original position, that is, the latched position. In the present embodiment, the repositioning element 160 is a spring, for example. The linking rod 142 is fastened to the pen cap 120. One end of the linking rod 142 extends to a location adjacent to the stopping block 150 so that a structural interference with the stopping block 150 is created.

In the present embodiment, the positioning mechanism 100 further includes a rocking arm 170. The rocking arm 170 has a fixed end 172 and a free end 174. The fixed end 172 is fastened to the position-limiting element 110. The free end 174 of the rocking arm 170 can oscillate with respect to the fixed end 172 when subjected to an external force. The stopping block 150 can be fastened to the rocking arm 170 between the fixed end 172 and the free end 174 so that the stopping block 150 can move following the motion of the rocking arm 170.

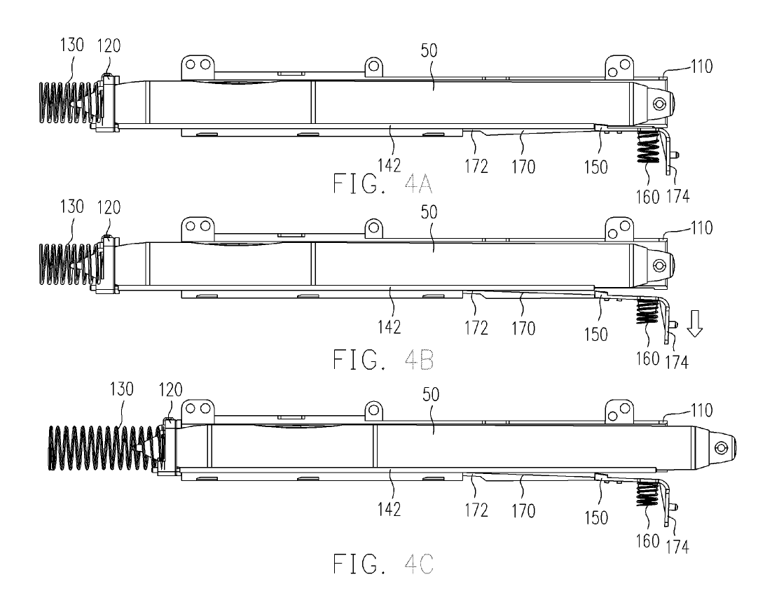

FIGS. 4A˜4C are a series of side views showing the process of ejecting a stylus from a positioning mechanism according to the first embodiment of the present invention. First, when the stylus 50 is accommodated inside the position-limiting element 110 of the positioning mechanism 100 as shown in FIG. 4A, the tip portion of the stylus 50 is plugged into and fixed inside the pen cap 120. Furthermore, the stopping block 150 disposed in the latched position restricts the movement of the linking rod 142 so that the stylus 50 not only is concealed inside the electronic device 10 but is very difficult to drop out from the positioning mechanism 100. Due to the squeezing action provided by the pen cap 120, elastic potential is stored in the pushing element 130.

As shown in FIG. 4B, a user applies an external force to the free end 174 of the rocking arm 170 when the user needs to remove the stylus 50 from the electronic device 10. Hence, the free end 174 shifts relatively to the fixed end 172 of the rocking arm 170. When the free end 174 moves relatively to the fixed end 172, the free end 174 will also drive the stopping block 150 and force the stopping block 150 to depart from the latched position as shown in FIG. 4A toward the unlatched position as shown in FIG. 4B. Meanwhile, as the stopping block 150 moves toward the unlatched position, the repositioning element 160 will be squeezed to store elastic potential. The repositioning element 160 is a spring, for example.

When the stopping block 150 is located in the unlatched position as shown in FIG. 4C, the elastic potential stored up in the pushing element 130 is released because there is no longer any structural interference between the stopping block 150 and the linking rod 142. Thus, the linking rod 142 and the stylus 50 will move towards the right side of the figure and expose a portion of the tail end of the stylus 50 outside the casing of the electronic device 10. As a result, the user can easily grasp the tail end portion of the stylus 50. Afterwards, a force is applied to release the latching between the stylus 50 and the pen cap 120 so that the stylus 50 can be retrieved from the position-limiting element 110.

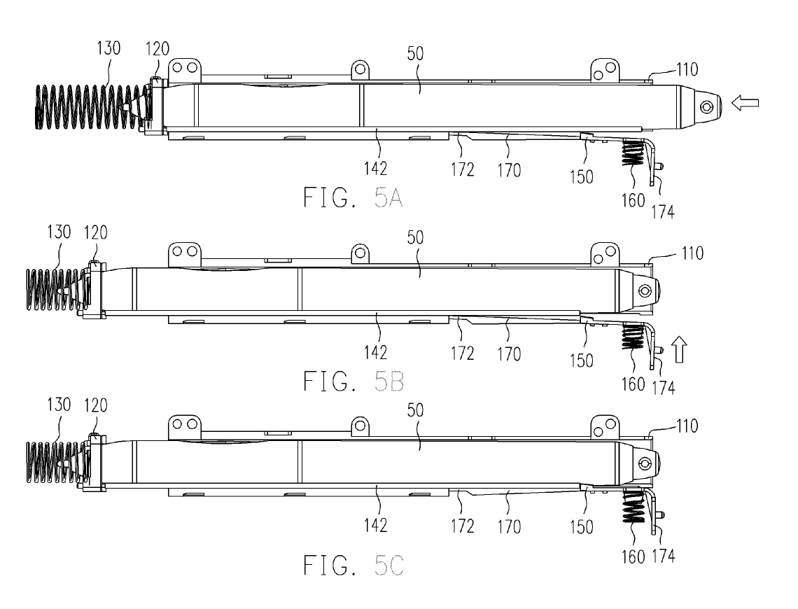

FIGS. 5A˜5C are a series of side views showing the process of returning a stylus to the positioning mechanism according to the first embodiment of the present invention. First, as shown in FIG. 5A, when a user needs to put the stylus 50 back to the electronic device 10 as shown in FIG. 1, the tip portion of the stylus 150 is inserted and fastened to the pen cap 120 at the bottom of the position-limiting element 110. Then, a force is applied to the stylus 50 to move the pen cap 120 and compress the pushing element 130. Thus, the remaining portion of the stylus 50 is accommodated inside the position-limiting element 110 until the linking rod 142 and the stopping block 150 no longer form a structural interference with each other. It should be noted that the stopping block 150 moves as a result of the pressure applied by the stylus 50 and the linking rod 142 in the process of pushing the stylus 50 into the position-limiting element 110. Consequently, the repositioning element 160 is indirectly compressed through the rocking arm 170.

As shown in FIG. 5B, when the linking rod 142 that moves to the left side no longer forms a structural interference with the stopping block 150, the compressed repositioning element 160 will release its elastic potential. Thus, through the indirect effect of the rocking arm 170, the repositioning element 160 returns the stopping block 150 to the latched position so that the stopping block 150 and the linking rod 142 form structural interference in the longitudinal direction of the stylus 50.

As shown in FIG. 5C, the stopping block 150 restricts the movement of the linking rod 142 in the longitudinal direction of the stylus 50 through the structural interference between the stopping block 150 and the linking rod 142. As a result, the movement of the pen cap 120 in the longitudinal direction of the stylus 50 is also restricted and the stylus 50 is accommodated inside the position-limiting element 110 of the positioning mechanism 100.

### Second Embodiment

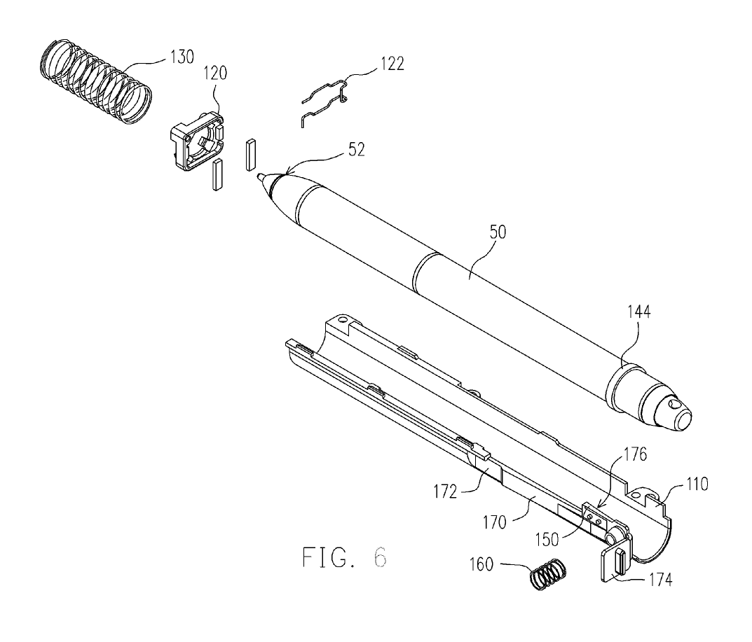

FIG. 6 is an exploded view showing the major components of a positioning mechanism and associated stylus according a second embodiment of the present invention. As shown in FIGS. 2 and 6, one major difference from the first embodiment is that the linking rod 142 serving as a stopping block receiver with stopping function is replaced by a circular bulging ring 144 that wraps around the periphery of the stylus 50. Furthermore, the circular bulging ring 144 serving as a stopping block receiver and having a stopping function will also form a structural interference with the stopping block 150 to restrict the movement of the stylus 50. In addition, the rocking arm 170 can have a slant surface 176, for example. The slant surface 176 is made to be contact with the circular bulging ring 144 so that the circular bulging ring 144 is able to compress the repositioning element 160 through the slant surface 176.

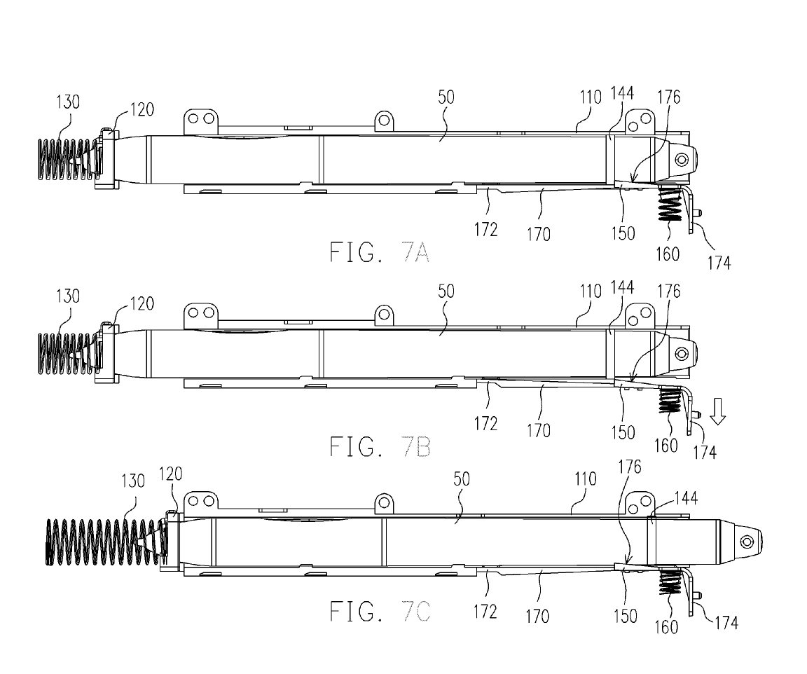

FIGS. 7A˜7C are a series of side views showing the process of ejecting a stylus from a positioning mechanism according to the second embodiment of the present invention. First, when the stylus 50 is accommodated inside the position-limiting element 110 of the positioning mechanism 100 as shown in FIG. 7A, the tip portion of the stylus 50 is plugged into and fixed inside the pen cap 120. Furthermore, the stopping block 150 disposed in the latched position restricts the movement of the circular bulging ring 144 so that the stylus 50 not only is concealed inside the electronic device 10 but is very difficult to drop out from the positioning mechanism 100. Due to the squeezing action provided by the pen cap 120, elastic potential is stored in the pushing element 130.

As shown in FIG. 7B, a user applies an external force to the free end 174 of the rocking arm 170 when the user needs to remove the stylus 50 from the electronic device 10. Hence, the free end 174 shifts relatively to the fixed end 172 of the rocking arm 170. When the free end 174 moves relatively to the fixed end 172, the free end 174 will also drive the stopping block 150 and force the stopping block 150 to depart from the latched position as shown in FIG. 7A toward the unlatched position as shown in FIG. 7B. Meanwhile, as the stopping block 150 moves toward the unlatched position in FIG. 7B, the shift in position of the circular bulging ring 144 will squeeze the slant surface 176 of the rocking arm 170 so that the repositioning element 160 is forced to move in a downward direction. The repositioning element 160 is a spring, for example. Hence, elastic potential is stored in the repositioning element 160.

When the stopping block 150 is located in the unlatched position as shown in FIG. 7C, the elastic potential stored in the pushing element 130 is released because there is no longer any structural interference between the stopping block 150 and the circular bulging ring 144. Thus, the stylus 50 is driven to move toward the right side of the figure and expose the end portion of the stylus 50 outside the casing of the electronic device 10. Hence, the user can easily grasp the tail portion of the stylus 50 and take out the stylus 120 from the position-limiting element 110 after applying a force to release latching engagement between the stylus 50 and the pen cap 120.

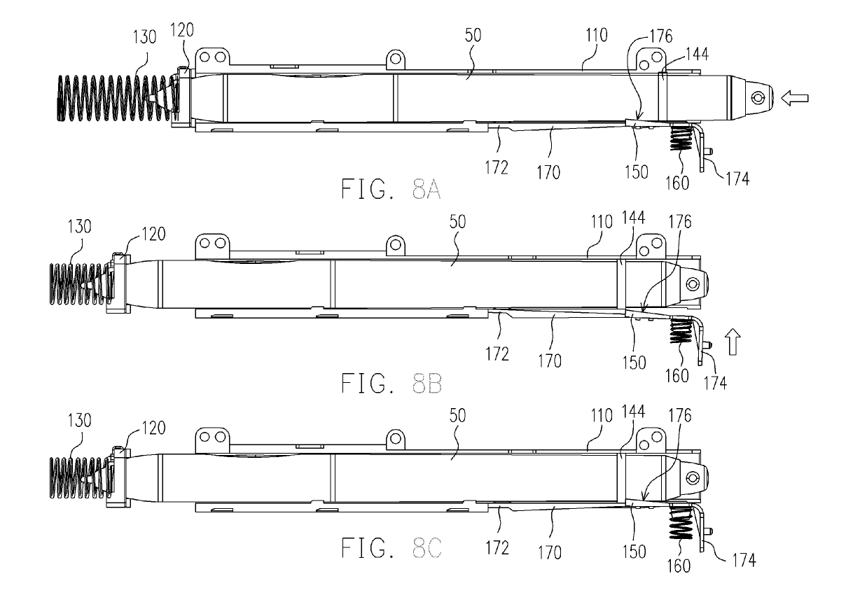

FIGS. 8A˜8C are a series of side views showing the process of returning a stylus to the positioning mechanism according to the second embodiment of the present invention. First, as shown in FIG. 8A, when a user needs to put the stylus 50 back to the electronic device 10 as shown in FIG. 1, the tip portion of the stylus 150 is inserted and fastened to the pen cap 120 at the bottom of the position-limiting element 110. Then, a force is applied to the stylus 50 to move the pen cap 120 and compress the pushing element 130. Thus, the remaining portion of the stylus 50 is accommodated inside the position-limiting element 110 until the circular bulging ring 142 and the stopping block 150 no longer form a structural interference with each other. It should be noted that the circular bulging ring 144 is able to apply a pressure to the slant surface 176 of the rocking arm 170 in the process of pushing the stylus 50 into the position-limiting element 110. Hence, the circular bulging ring 144 can enter deep into the position-limiting element 110 along the slant surface 176. In addition, the slant surface 176 can move the stopping block 150 toward the unlatched position and compress the repositioning element 160 indirectly through the rocking arm 170.

As shown in FIG. 8B, when the circular bulging ring 144 that moves to the left side no longer forms a structural interference with the stopping block 150, the compressed repositioning element 160 will release its elastic potential. Thus, through the indirect effect of the rocking arm 170, the repositioning element 160 returns the stopping block 150 to the latched position so that the stopping block 150 and the circular bulging ring 144 form a structural interference in the longitudinal direction of the stylus 50.

As shown in FIG. 8C, the stopping block 150 restricts the movement of the circular bulging ring 144 in the longitudinal direction of the stylus 50 through the structural interference between the stopping block 150 and the circular bulging ring 144. As a result, the movement of the pen cap 120 in the longitudinal direction of the stylus 50 is also restricted and the stylus 50 is accommodated inside the position-limiting element 110 of the positioning mechanism 100.

It should be noted that the linking rod 142 and the circular bulging ring 144 that serve as a stopping block receiver with stopping function in the first and the second embodiment are examples only. In other embodiment, the stopping block receiver can be some other structural form so long as it can form a structural interference with the stopping block 150 and its movement is restricted or permitted according to the location of the stopping block 150.

In summary, the positioning mechanism of the present invention is installed inside an electronic device for housing a stylus. When a user needs to take out the stylus from an electronic device, a force is applied to the move the stopping block until the stopping block receiver and the stopping block no longer form a structural interference. Through the pushing element in the positioning mechanism, the stylus is moved so that a portion (for example, the tail portion) of the stylus is exposed outside the electronic device and the user can easily grab the exposed portion of the stylus. After releasing the gripping (or latching) relation between the pen cap and the stylus, the stylus can be taken out from the electronic device. Conversely, when the user wants to return the stylus to the electronic device, the structural interference between the stopping block receiver and the stopping block is utilized to limit the release of elastic potential. Through the gripping (or latching) relation between the stylus and the pen cap, the stylus is maintained at a fixed position inside the electronic device. In other words, through the positioning mechanism provided by the present invention, a stylus can be easily housed inside an electronic device or retrieved from the electronic device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A positioning mechanism for accommodating a stylus inside an electronic device, the positioning mechanism comprising:
a position-limiting element with an accommodating space for housing the stylus;
a pen cap located at one end of the position-limiting element for gripping the stylus;
a pushing element fastened to the pen cap, wherein a pushing force for pushing the stylus out of the position-limiting element is produced when the pushing element is compressed;
a linking rod fastened to the pen cap, wherein the linking rod moves along with the pen cap;
a stopping block located on one side edge of the position-limiting element for restricting the movement of the linking rod when the stopping block is in a latched position and allowing free movement of the linking rod when the stopping block is in an unlatched position; and
a repositioning element fastened to the stopping block, wherein the repositioning element provides a force returning the stopping block to the latched position when the repositioning element is compressed.

2. The positioning mechanism of claim 1, wherein the linking rod is a stopping block receiver with stopping capability and the linking rod extends a distance from the pen cap in the longitudinal direction of the stylus towards the stopping block.

3. The positioning mechanism of claim 1, wherein the pen cap further comprises a gripping element for holding onto a circular groove thread on the stylus.

4. The positioning mechanism of claim 1, wherein the pushing element comprises a spring.

5. The positioning mechanism of claim 1, wherein the mechanism further includes a rocking arm having a fixed end and a free end such that the fixed end is fastened to the position-limiting element and the free end is able to oscillate with respect to the fixed end when subjected to an external force, and furthermore, the stopping block is fastened to the rocking arm between the fixed end and the free end so that the stopping block moves together with the rocking arm.

6. The positioning mechanism of claim 1, wherein the repositioning element comprises a spring.

7. A positioning mechanism for accommodating a stylus inside an electronic device, the positioning mechanism comprising:
a position-limiting element with an accommodating space for housing the stylus;
a pen cap located at one end of the position-limiting element for gripping the stylus;
a pushing element fastened to the pen cap, wherein a pushing force for pushing the stylus out of the position-limiting element is produced when the pushing element is compressed;
a circular bulging ring fastened to the stylus, wherein the circular bulging ring is able to move along with the stylus;
a stopping block disposed on one side edge of the position-limiting element for restricting the movement of the circular bulging ring when the stopping block is in a latched position and allowing free movement of the circular bulging ring when the stopping block is in an unlatched position; and
a repositioning element fastened to the stopping block, wherein the repositioning element provides a force returning the stopping block to the latched position when the repositioning element is compressed.

8. The positioning mechanism of claim 7, wherein the circular bulging ring is a stopping block receiver with stopping capability and the circular bulging ring wraps around the periphery of the stylus.

9. The positioning mechanism of claim 7, wherein the pen cap further comprises a gripping element for holding onto a circular groove thread on the stylus.

10. The positioning mechanism of claim 7, wherein the pushing element comprises a spring.

11. The positioning mechanism of claim 7, wherein the mechanism further includes a rocking arm having a fixed end and a free end such that the fixed end is fastened to the position-limiting element and the free end is able to oscillate with respect to the fixed end when subjected to an external force, and furthermore, the stopping block is fastened to the rocking arm between the fixed end and the free end so that the stopping block moves together with the rocking arm.

12. The positioning mechanism of claim 7, wherein the repositioning element comprises a spring.
